(19) United States
(12) Patent Application Publication
(10) Pub. No.: US 2018/0285971 A1
(43) Pub. Date: Oct. 4, 2018

(54) MANAGEMENT OF CONSUMER DEBT COLLECTION USING A BLOCKCHAIN AND MACHINE LEARNING

(71) Applicant: International Business Machines Corporation, Armonk, NY (US)

(72) Inventor: Jonathan M.C. Rosenoer, Chadds Ford, PA (US)

(21) Appl. No.: 15/475,953

(22) Filed: Mar. 31, 2017

(51) Int. Cl. G06Q 40/02; G06N 99/00; G06F 17/30

(52) U.S. Cl. CPC G06Q 40/025; G06F 17/30979; G06N 99/005

(57) ABSTRACT

A blockchain of transactions may be referenced for various purposes and may be later accessed by interested parties for ledger verification and information retrieval. One example operation may include one or more of identifying a new event associated with a consumer debtor account, determining whether the new event includes a status change or debt related change, creating a file including the new event, and storing the file in a blockchain.

### TECHNICAL FIELD

This application generally relates to the management of consumer debt collection, enforcement or sale via blockchain and machine learning, and more particularly, to managing and measuring the state of consumer debt information in a distributed computing environment.

### BACKGROUND

Blockchain is a type of computing architecture that enables a peer-to-peer distributed (shared and replicated) database or ledger, not controlled by a single organization or entity, but many different ones. Spanning across a network of independent machines, the configuration permits the nodes to reliably track and maintain the state of information in a system. In doing so, blockchain enables the cost-efficient creation of business networks without requiring a central point of control. This configuration operates in contrast to traditional database-oriented systems, where independent parties maintain their own systems of record and reconcile updates with one another in inefficient and sometimes complex inter-organizational processes, which requires the services of an independent, trusted third-party administrator.

Blockchains securely create and update ‘state’ across the network nodes according to specific rules that govern the right to perform state transitions. Consensus mechanisms (algorithms) enable the rights to be securely distributed and collectively undertaken, without the need for a middleman between the parties to a transaction. There are many different mechanisms that can used to build consensus.

A key attribute of the blockchain is that it does not permit changes to data that has been committed (immutable ledger). In the blockchain environment, the consensus mechanism enables the nodes to continuously and sequentially record transactions on a “block,” creating a unique “chain” (referred to as the blockchain). Cryptography, via hash codes, is used to secure the authentication of the transaction source and removes the need for a central intermediary.

The roles and access rights of blockchain participants can be tailored particularly in what is known as a permissioned blockchain, to align the consensus mechanism with the needs of a particular ecosystem. Further, blockchain participants can be partitioned within discrete channels, so that participants connecting to one channel are unaware of the existence of other channels.

While early blockchain implementations tracked transactions (e.g., digital currency), it can store any type of digital information, asset, or instruction, ranging in context from health care information to securities, global shipping and logistics. Data can be embedded directly in a blockchain, or can be connected via storage mechanisms, which may be decentralized and distributed.

Basic blockchain functionality includes creating, modifying, and deleting an asset, or reading the state of a ledger. This functionality can be expanded by incorporating runtime environments (virtual machines) in the core blockchain technology. This enables computer program/application code (e.g., smart contracts, chaincode) to be stored, verified and executed on the blockchain.

A risk in consumer lending is that debt will not be repaid. Those debts, for example, may be related to credit made available in the areas of credit card, auto, home-equity, mortgage, and student loans among other types of debts. When debt holding parties do not make payments and go into default, the creditor (a bank, for example) may try to collect on debt itself, or by using third-party debt collection firms, and filing claims in courts and other enforcement agencies as appropriate. If the outstanding debt is not recovered within a certain period, the creditor may also select to sell the debt to debt buyers, potentially subject to “put-back” and “recall” rights.

The consumer debt collection and litigation process is subject to a range of legal measures designed to protect consumers. For example, the Fair Debt Collection Practices Act (“FDCPA”), prohibits debt collectors from engaging in unfair, deceptive, and abusive acts and practices in collection of debts, and also requires that “validation notices” are provided to consumers setting forth basic information about their debts and rights. Similarly, the Fair Credit Reporting Act (“FCRA”) imposes accuracy standards on credit bureaus and entities that provide such information.

Under Federal and state laws, creditors such as banks and other participants in the consumer debt collection and litigation process are exposed to substantial risks associated with the accuracy of debt balances, information about the underlying consumer accounts, the validity of account documents, the updated status of debt entities, and accurate reporting to stakeholders, including courts and credit bureaus. For example, large U.S. banks have been found in violation of consumer protection laws for selling debt with missing or erroneous information on the amount owed already settled by agreement, paid in full, discharged in bankruptcy, identified as fraudulent and not owed, subject to an agreed-upon payment plan, no longer owned, or otherwise no longer enforceable. Similarly, law firms engaged in associated debt collection litigation have been found to have engaged in unlawful practices by failing to review necessary documentation to support the validity of claims being asserted and utilizing client affidavits that they should have known were unreliable.

To ensure compliance with consumer protection laws when collecting and selling, banks have agreed, among other things, to implement policies, procedures, systems, and controls to ensure the accuracy of debt information, to notify consumers when their account is sold, disclose who purchased the account, and the amount owed at the time of sale, and, to update consumer credit reports when a consumer debt is eliminated, in whole or in part, in bankruptcy.

U.S. total household debt is currently over 12 trillion dollars. Total outstanding consumer credit (non-mortgage debt) is over 3.6 trillion dollars. Banks and associated creditors are beginning to increase their debt collection litigation efforts. Banks are seeking to reinstitute debt sales to third parties interested in enforcing the debt as a business model. Certain estimates indicate the sale of recently discharged debt would generate hundreds of millions of dollars.

In general, the challenges faced by creditor banks and the multiple parties engaged in debt collection, litigation and sales can be attributed to gaps in the state of information between the parties. Blockchain provides a unique architecture to store and update information between the different parties in an efficient, cost-effective, secure and auditable manner.

Applying machine learning to the system, particularly regarding the recorded outcomes, will enhance the value of debt being bought and sold, as it will reduce the uncertainty around the underlying obligations that are to be sold and the expected recovery rate. This will increase the willingness of investors to fund debt purchases and raise the price for which the bank can sell the debt.

### SUMMARY

One example method of operation includes one or more of identifying a new event associated with a consumer debtor account, determining whether the new event comprises a status change or a debt related change, creating a file update including the new event and the status change or debt related change, and storing the updated file in a blockchain.

Another example embodiment provides an apparatus that includes one or more of a processor configured to identify a new event associated with a consumer debtor account, determine whether the new event comprises a status change or debt related change, create a file update including the status change or debt related change and the new event, and store the file in a blockchain.

Still another example embodiment provides a non-transitory computer readable storage medium comprising instructions which, when executed, cause a processor to perform one or more of identifying a new event associated with a consumer debtor account, determining whether the new event comprises a status change or a debt related change, creating a file update including the new event and the status change or debt related change, and storing the updated file in the blockchain.

### BRIEF DESCRIPTION OF THE DRAWINGS

FIG. 1A illustrates a logic diagram of consumer record creation in the blockchain, according to example embodiments.

FIG. 1B illustrates a blockchain system configuration according to example embodiments.

FIG. 2 illustrates a system signaling diagram of the interactions between a client device and the blockchain, according to example embodiments.

FIG. 3A illustrates a flow diagram of an example method of managing consumer debt in the blockchain, according to example embodiments.

FIG. 3B illustrates another flow diagram of an example method of managing consumer debt in the blockchain, according to example embodiments.

FIG. 4 illustrates an example network entity configured to support one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

A blockchain provides a system configuration to reduce substantial risks that creditors, and creditor banks in particular, and consumer debt collection and litigation process participants, and also debt buyers, may experience, including, but not limited to, accuracy of debt balances, information about the status of debt having parties, underlying debt accounts, validity of account documents, permissions to call mobile phones, and reporting to stakeholders (including courts and credit bureaus). For example, the Fair Debt Collection Practices Act (FDCPA) prohibits debt collectors from engaging in unfair, deceptive, and abusive acts and practices in collecting debts, and also requires that “validation notices” are provided to consumers setting forth basic information about their debts and rights. Further, the Fair Credit Reporting Act (FCRA) imposes accuracy standards on credit bureaus and entities that provide such information. In addition, the Telephone Consumer Protection Act (TCPA) prohibits businesses from making any “call” to a consumer's mobile phone without the customer's “prior express consent”, and, the Service Member's Civil Relief Act (SCRA) provides a wide range of protections, including postponing or suspending certain civil obligations, for individuals entering, called to active duty, or otherwise deployed service members in the military.

All these regulations increase the stakes for the creditor related entities to abide by the laws and have accurate and updated information regarding debts. Large banks have been found to violate consumer protection laws for selling debt with missing or erroneous information on the amount owed, already settled by agreement, paid in full, discharged in bankruptcy, identified as fraudulent and not owed, subject to an agreed-upon payment plan, no longer owed and/or otherwise no longer enforceable. Agencies, such as law firms engaged in debt collection litigation, may also engage in unlawful practices by failing to review necessary documentation to support the validity of claims being asserted, and by utilizing client affidavits that they should have known were unreliable. For instance, a law firm must demonstrate, for every lawsuit filed, an “Original Account-Level” documentation from the client was received and reviewed and the statute of limitations must also be also verified, venue must be proper, and the consumer must not have already filed bankruptcy.

Blockchains and related cognitive data operations may optimize the multi-party, multi-faceted debt collection and litigation processes to meet compliance requirements by identifying the correct state of information between the parties. With added compliance comes increases in the value and attractiveness of debt portfolios and the overall debt marketplace as the likelihood of maintaining compliance and debt validity may be increased.

A decentralized (peer-to-peer) data structure technology, such as a blockchain “ledger”, enables cryptographically secured publication, distribution and updating of accurate data on any particular consumer debt across a debt collection process, including identification of the original creditor, debtor (indebted party), debt buyer, debt collection agency, collection law firm, court, and credit bureau. Operating as a trusted, distributed virtual computing machine, the blockchain can store debt related state information that is shared instantaneously across all network nodes, and which is auditable by any authorized party. Utilizing Turing complete scripting languages and associated software development kits (SDKs) and application programming interfaces (APIs), blockchain alerting and reporting features can also trigger alerts about changes to stored state information as well as more formal messaging that can be sent electronically, as well as functions related to the debt sale process, including the offering and acceptance of contract terms and associated payments. As a result, the blockchain can eliminate third party administrators, intra/inter-organization technology architecture, software application silos, and associated dependencies that contribute to latency, inefficiency, and cost.

The instant application relates, in some embodiments, to the management of consumer debt collection, enforcement or sale via blockchain and machine learning, and more particularly, to managing and measuring the state of consumer debt information in a distributed computing environment.

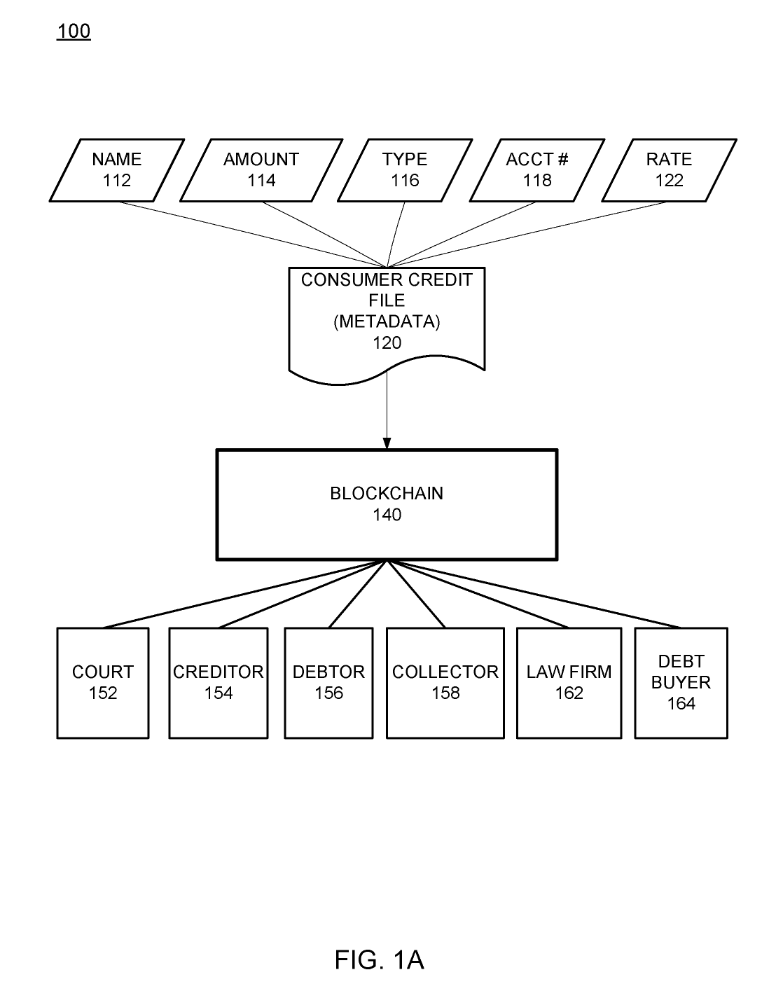

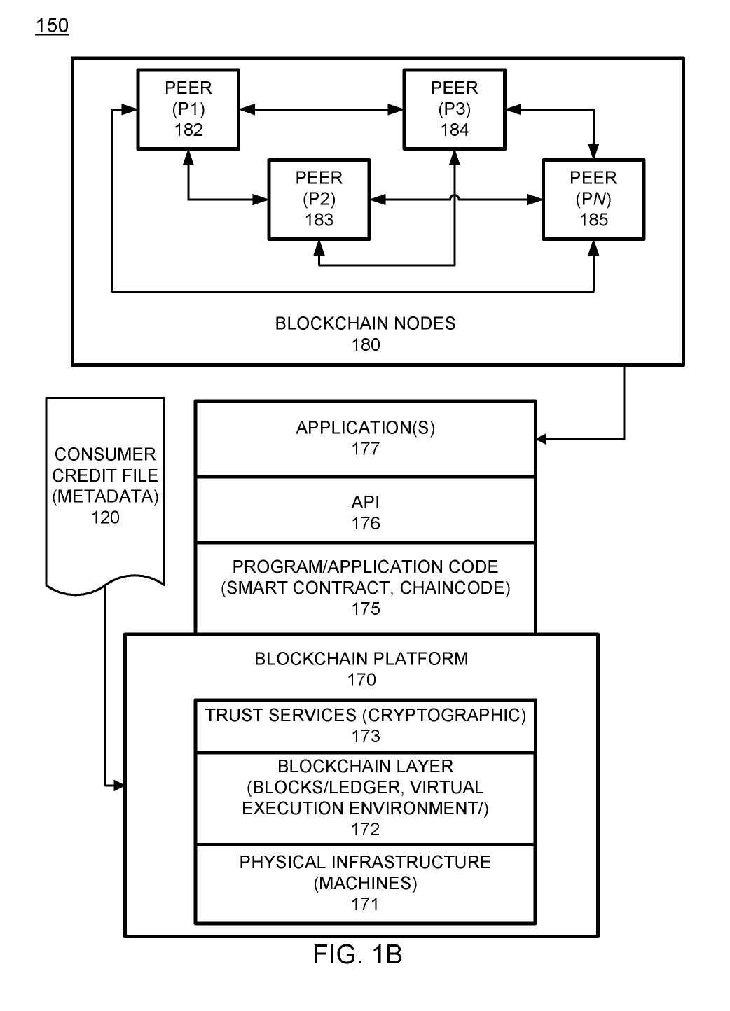

FIG. 1A illustrates a logic diagram of establishing a consumer account credit file in the blockchain, according to example embodiments. Referring to FIG. 1A, the logic configuration 100 includes various metadata parameters that may be identified and provide the logical structure of the consumer credit file 120 as data fields 112-122. The fields described by the metadata 120 may include a type of credit (i.e., card, car, house, etc.), an amount owed (principal and interest), a name, address, phone number, social security number, account number, original balance, charge-off balance, charge-off date, date account opened, date of last payment, interest rate, date of default, recent credit score, bankruptcy filing (Y/N), security interest, and state of consumer residence. Credit file 120 content may be updated for any new event or action taken with regard to the consumer debtor and the underlying debt, such as, for example, appointment of debtor counsel, revocation of consent for calls made to the debtor's cellphone, etc., with the result that the update to the credit file 120 is committed to and stored within, the blockchain 140.

Any permissioned interested party with the proper cryptographic credentials may access a consumer account credit file, including the data defined by the metadata associated with a particular debtor, and read or write to that file according to such permissions. For instance, permissioned parties may include a creditor 154, a collector or collection agency 158, a law firm 162, or a debt buyer 164, etc. In the example of a collector 158, such as an in-house bank collector, the collector may update the credit file and upload and commit the updated data to the blockchain 140 including dispute history and partial payment received from, a debtor 156. This action may trigger the blockchain platform, via the virtual execution environment, to execute logic built stored in the blockchain platform, via a “smart contract” or chaincode, to report the associated partial payment information to a credit bureau on behalf of the creditor 154.

Also, in the example of a creditor 154, the creditor may assign the case to a collection agency 158 through the blockchain platform, with embedded logic and procedures that handle the offer and acceptance process, provides access to the debt files covered by the contract, etc. The collection agency 158 may trigger the blockchain platform to send required notices to the debtor 156, enabled by the blockchain virtual machine, which can also send validation, dispute, and verification communications. The collection agency 158 can also update the debt file by the blockchain including collection history, skip-tracing information, etc. The creditor 154 can send credit file correction/update information to the blockchain, which, in turns, can send alerts/notifications to debt collection participants. Such information may include internal creditor collectors, other internal creditor lines of business, a third-party collection agency, a debt buyer 164, a collection law firm 162, state court 152, bankruptcy court, and the debtor 156. The blockchain receives the updates and via embedded logic, such as a “smart contract” or chaincode, executed by the blockchain virtual machine, sends reports/updates to the credit bureau on behalf of the creditor. The blockchain platform, similarly via such embedded logic, can calculate collection litigation time-bar information and sends alerts/notifications to debt collection participants, which may include internal creditor collectors, third-party collection agencies, debt buyers, collection/law firms. The creditor 154 loads sworn documents into the blockchain, and the blockchain platform, also via such embedded logic, validates sworn documents against credit file data and sends validated sworn documents to collection counsel which, in turn, files sworn documents with courts such as state court and bankruptcy court.

FIG. 1B illustrates a blockchain system configuration according to example embodiments. Referring to FIG. 1B, the blockchain system 150 may include certain common blockchain elements, such as a group 180 of assigned peers 182-185 which participate in the blockchain transaction addition and validation process (consensus). Any of the blockchain peer nodes 180 may initiate new transactions and seek to write to the blockchain immutable ledger 172, a copy of which is stored on, and replicate to, the underpinning physical infrastructure 171. In this configuration, the customized blockchain configuration may include one or applications 177 which are linked to APIs 176 to access and execute stored program/application code (e.g., chain code and/or smart contracts) 175, which are created according to the customized configuration sought by the participants and can maintain their own state, control its own assets, and receive external information. This code can be deployed as a transaction and installed, via appending to the distributed ledger, on all blockchain peer nodes.

The blockchain base 170 includes the various layers of blockchain data, services (e.g., cryptographic trust services, virtual execution environment), and underpinning physical computer infrastructure necessary to receive and store new transactions and provide access to auditors which are seeking to access data entries. The blockchain layer 172 exposes an interface that provides access to the virtual execution environment necessary to process the program code and engage the physical platform 171. Cryptographic trust services 173 are used to verify transactions and keep information private. By these means, a consumer debtor data file 120 can be created and updated on the blockchain to accurately update consumer debt information.

The blockchain configuration of FIG. 1B may process and execute program/application code 175 by means of the interfaces exposed, and the services provided, by blockchain platform 170. The code may control blockchain assets, for example, it can store and transfer data, and may be executed by the blockchain in the form of a smart contract, which includes chain code with conditions or other code elements subject to its execution. The smart contracts 175 may be created to execute reminders, updates, and/or other notifications subject to the debtor's status (i.e., changes, updates, etc.). The smart contracts can themselves identify balances, control other smart contract programs, or act as triggers based on information received and certain desired results. Once the smart contracts are created, they can act autonomously, receiving information inputs and determining when to perform an action.

In another example of debt management processes managed by the blockchain system, the debtor 156 may file for bankruptcy and the collection law firm 162 files a proof of claim with the bankruptcy court 152 and the collection law firm updates the blockchain 140 with the proof of claim information. The collection law firm 162 updates the blockchain with bankruptcy data information by updating the consumer credit file 120 and storing this information in the blockchain by means of program code 175. The bankruptcy court can issue debt relief to the creditor, which either reduces or eliminates debt. The bankruptcy court may, for example, notify the collection law firm of the discharge of the consumer's debt, which information would be update in the consumer debt file stored in the blockchain. The blockchain platform could then send an update to a credit bureau respecting the creditor modified or eliminated debt.

In a further example of debt management processes managed by the blockchain system, the creditor makes a debt sale offer via blockchain platform 170. The debt buyer 164 receives pre-sale disclosure from the creditor via blockchain. The debt buyer accepts a debt sale offer by creditor via the blockchain platform 170, and the debt buyer acceptance triggers payment to the creditor by the blockchain platform 170, and the debt buyer receives an at-sale disclosure from the blockchain platform 170. The debt buyer receives post-sale information from the blockchain platform 170.

In another example, artificial intelligence (AI) capabilities, such as machine learning, are integrated with the blockchain by means of applications 177, program code 175, the virtual execution environment and data stored in the Blocks 172. As an output, for example, the AI can analyze the lifecycle changes within individual credit files and across portfolios of credit files, providing information to stakeholders that enhances the value of consumer debt portfolios held for sale. As a further example, the AI can alert the stakeholders to changes in laws and regulations that impact the debt collection process.

In another example, a machine learning approach is implemented that includes a state-observing unit, a learning unit, and a decision-making unit. The state observing unit communicates with the blockchain platform, queries credit files, and obtains data contained in those files and updates them accordingly as changes are identified. The state-observing unit can be securely permissioned (cryptographically) by the blockchain platform to query data and receive data from credit files stored in a single blockchain channel containing the consumer debt held by a single creditor or across blockchain channels containing the consumer debt of multiple creditors, each of which maintains a discrete blockchain channel. The information gathered by the state observing unit is transmitted to the learning unit. After completing a learning phase, the learning unit detects and identifies certain patterns in the data of the previously created credit files. The learning technologies utilized by the learning unit can be implemented as supervised learning or unsupervised learning. The patterns identified by the learning unit related to debt type, geographic location of the debt and/or debtor, collection and litigation recovery metrics, bankruptcy resolutions, etc. The learning unit transmits the patterns to the decision-making unit, which provides recommendations on optimal approaches for debt collection and value maximization. In part, this information is utilized by creditors to maximize the value of debt sales and by debt buyers and investors to optimize their returns.

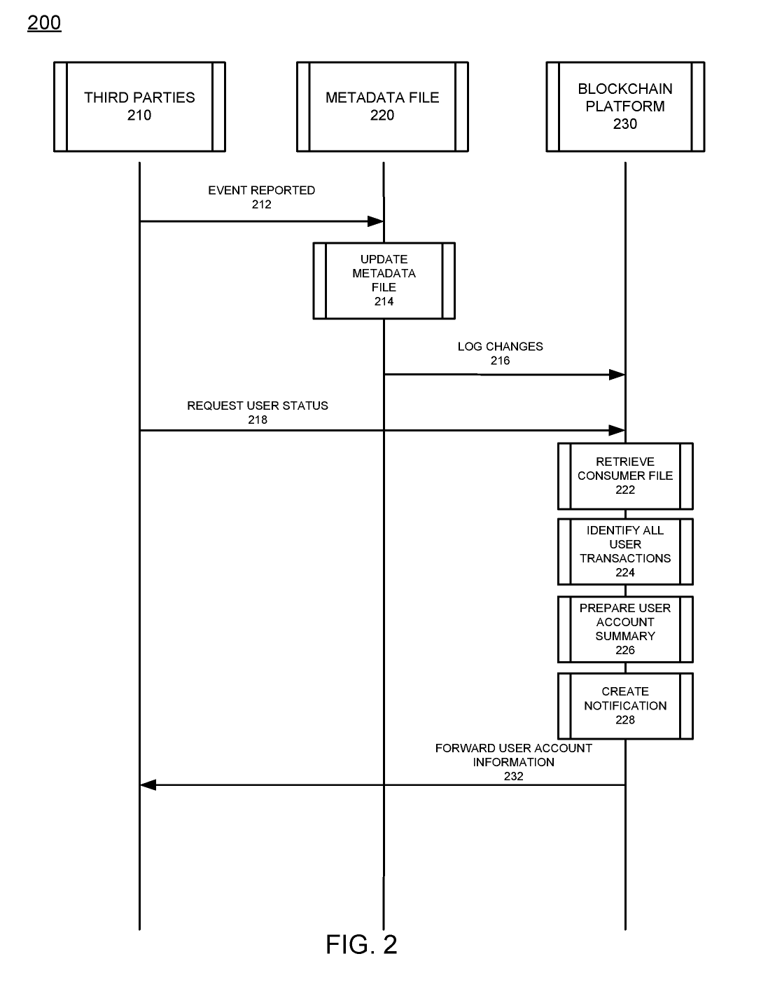

FIG. 2 illustrates a system signaling diagram of the interactions between an end user interacting with the blockchain platform, according to example embodiments. Referring to FIG. 2, in this system configuration 200 the entities included are end users (herein, third parties) 210, the consumer credit file 220 and the blockchain platform 230. One example method of operation may include the third parties reporting events 212, a change in the status of the debtor, such as a bankruptcy filing or revocation of consent to call a cellphone, or change in the debt balance due to correction of an interest rate calculation. The consumer credit file 220 may be updated 214 to reflect such events. The changes and/or new information may be written to and stored on the blockchain 216, each time as a transaction in the blockchain 230. Thereafter, a request may be received 218 to query the status of the debtor via the access to such information in the blockchain, which may include retrieving the consumer credit file 222 associated with a consumer account, identifying all transactions 224 associated with the consumer account, preparing an account summary 226, creating a notification 228 and communicating the summary information 232 to a third party 210.

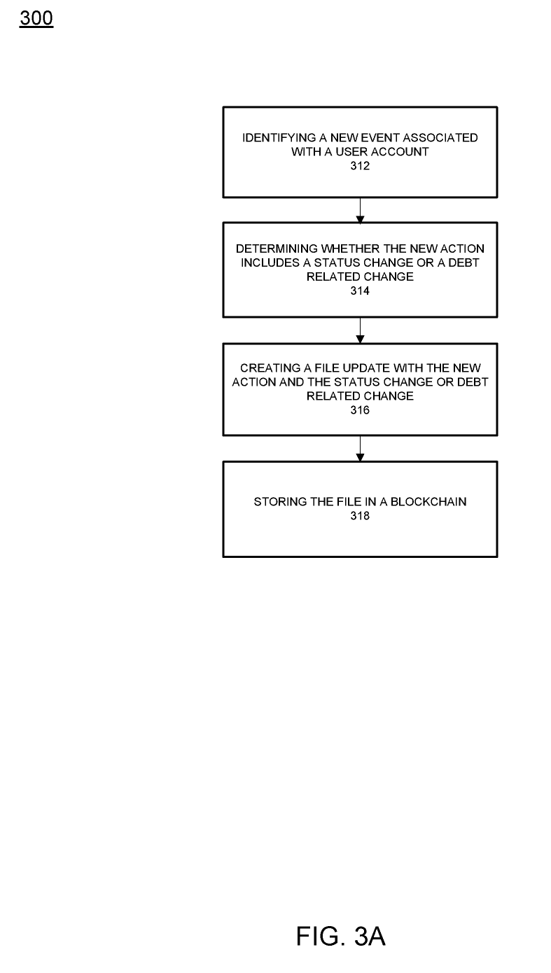

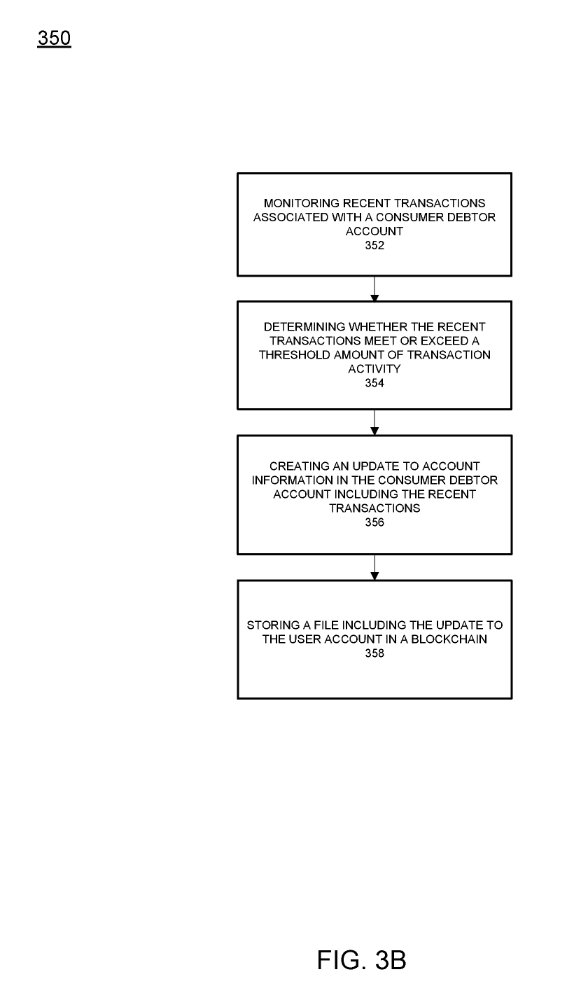

FIG. 3A illustrates a flow diagram of an example method of managing consumer debt in the blockchain, according to example embodiments. Referring to FIG. 3A, the method 300 may include one or more of identifying a new event associated with a consumer debtor account 312, determining whether the new event represents a status change or debt related change 314, creating a file update comprising the new event and associated status change 316, and creating or updating the file data in a blockchain 318. The new action includes one or more of a new line of credit, a cancelled line of credit, a litigation record, a purchase and a sale. The status change may include a change in the status of the debtor, such as a bankruptcy filing or revocation of consent to call a cellphone, or change in the debt balance due to correction of an interest rate calculation. Not all change may be status changes, such as a correction of an interest rate calculation may change a balance owed, however, such a change may not change a user account status.

The example method may also provide identifying one or more parties requesting access to the metadata file, retrieving the metadata file, and accessing a plurality of user account transactions stored in the blockchain using data stored in the credit file. The method may further include creating a notification include the plurality of user account transactions, and transmitting the notification to the plurality of parties. The method may also include receiving an update to the credit file, updating the credit file, and storing the updated credit file in the blockchain. The method may further provide retrieving a plurality of third parties registered to receive update information, creating a notification including the update to the credit file, and transmitting the notification to the plurality of parties. The plurality of third parties may be stored in a separate field in the credit file linked to the debtor's account.

FIG. 3B illustrates another flow diagram of an example method of managing consumer debt in the blockchain, according to example embodiments. Referring to FIG. 3B, the method 350 may include one or more of monitoring recent transactions associated with a particular consumer debtor's account 352, determining whether the recent transactions meet or exceed a threshold amount of transaction activity 354, creating an update to the debtor's account information in the debtor's account comprising the recent transactions 356, and storing a credit file including the update to the debtor's account in a blockchain 358. Once a debtor's account is being tracked, the debtor may have consented to ongoing investigation/tracking/monitoring by a credit extending authority (e.g., credit card company, automobile lender, etc.). The debtor account can be tracked on any device which accesses the debtor account to perform purchases and other selection activities which could adversely affect the debtor's account status from a creditworthiness perspective. For instance, if a debtor is seeking a line of credit to purchase an automobile, the line of credit may be held in abeyance pending further investigation. Such investigation efforts may include an automated tracking procedure which compares the user's purchase activities over the course of a day, week, month, etc., to a baseline model that is considered acceptable according to a credit standard or private industry standard. This enables the tracking of user account spending to determine whether a debtor is acting appropriately from a financial risk perspective, including regulatory driven assessment of the consumer's ability to pay. If the debtor account is identified as having made too many purchases of too large an amount as compared to the baseline standard, then the decision to extend the user account the requested line of credit may result in a denial or rejection.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

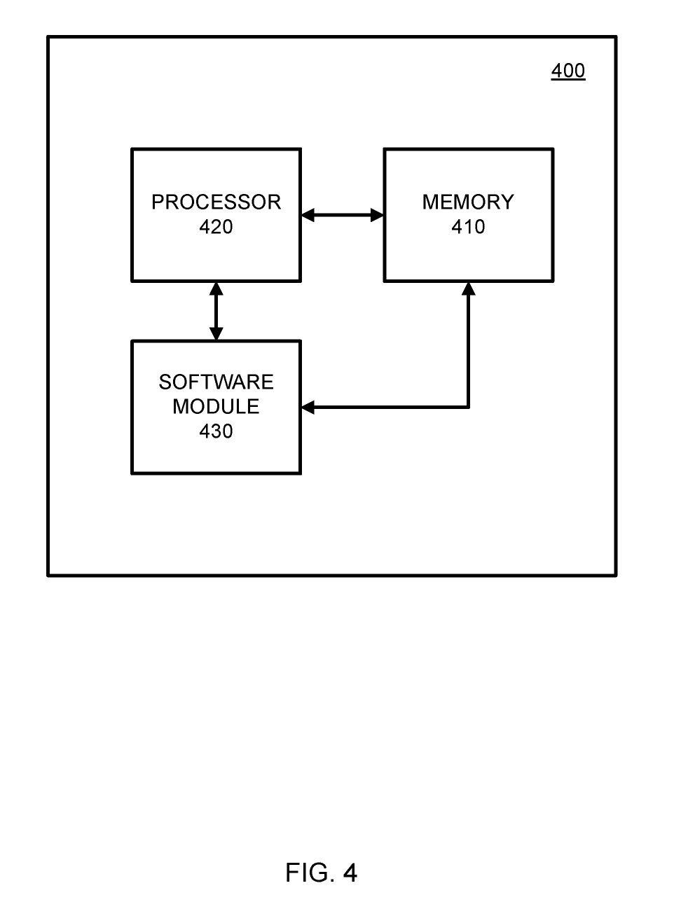

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 4 illustrates an example network element 400, which may represent or be integrated in any of the above-described components, etc.

As illustrated in FIG. 4, a memory 410 and a processor 420 may be discrete components of a network entity 400 that are used to execute an application or set of operations as described herein. The application may be coded in software in a computer language understood by the processor 420, and stored in a computer readable medium, such as, a memory 410. The computer readable medium may be a non-transitory computer readable medium that includes tangible hardware components, such as memory, that can store software. Furthermore, a software module 430 may be another discrete entity that is part of the network entity 400, and which contains software instructions that may be executed by the processor 420 to effectuate one or more of the functions described herein. In addition to the above noted components of the network entity 400, the network entity 400 may also have a transmitter and receiver pair configured to receive and transmit communication signals (not shown).

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
identifying a new event associated with a consumer debtor account;
determining whether the new event comprises a status change or debt related change;
creating a file update comprising the status change or the debt related change and the new event; and
storing the file in a blockchain.

2. The method of claim 1, wherein the new event comprises one or more of a change in debt calculation, a status change of the consumer debtor, a new line of credit, a cancelled line of credit, a litigation record, a purchase, a sale, and wherein the status change or debt related change comprises one or more of an increase in debt, a decrease in debt and a change in credit status.

3. The method of claim 1, further comprising:
identifying one or more parties requesting access to the file;
retrieving the file; and
accessing a plurality of transactions stored in the blockchain using metadata stored in the file.

4. The method of claim 3, further comprising:
creating a notification comprising a plurality of consumer debtor account transactions; and
transmitting the notification to the plurality of parties.

5. The method of claim 1, further comprising:
receiving an update to the file;
updating the file; and
storing the updated file in the blockchain.

6. The method of claim 5, further comprising:
retrieving a plurality of third parties registered to receive updated information;
creating a notification comprising the update to the file; and
transmitting the notification to the plurality of parties.

7. The method of claim 6, wherein the plurality of third parties are stored in a separate file that is linked to the consumer debtor account.

8. The method of claim 1, further comprising:
querying a plurality of consumer debt files stored in the blockchain;
identifying one or more patterns associated with one or more of a debt type, a geographic location of a debt, collection and litigation recovery metrics, and a bankruptcy resolution; and
creating one or more recommendations for debt collection optimization and a debt value sale based on the one or more patterns identified.

9. An apparatus, comprising:
a processor configured to:
identify a new event associated with a consumer debtor account;
determine whether the new event comprises a status change or debt related change;
create a file update comprising the status change or the debt related change and the new event; and
store the file in a blockchain.

10. The apparatus of claim 9, wherein the new event comprises one or more of a change in debt calculation, a status change of the consumer debtor, a new line of credit, a cancelled line of credit, a litigation record, a purchase, a sale, and wherein the status change or debt related change comprises one or more of an increase in debt, a decrease in debt and a change in credit status.

11. The apparatus of claim 9, wherein the processor is further configured to
identify one or more parties requesting access to the file;
retrieve the file; and
access a plurality of transactions stored in the blockchain using metadata stored in the file.

12. The apparatus of claim 11, wherein the processor is further configured to
create a notification comprises a plurality of consumer debtor account transactions; and
transmit the notification to the plurality of parties.

13. The apparatus of claim 9, further comprises:
a receiver configured to receive an update to the file, and
wherein the processor is further configured to
update the file; and
store the updated file in the blockchain.

14. The apparatus of claim 13, wherein the processor is further configured to
retrieve a plurality of third parties registered to receive updated information,
create a notification comprising the update to the file, and
transmit the notification to the plurality of parties, wherein the plurality of third parties are stored in a separate file that is linked to the consumer debtor account.

15. The apparatus of claim 9, wherein the processor is further configured to
query a plurality of consumer debt files stored in the blockchain,
identify one or more patterns associated with one or more of a debt type, a geographic location of a debt, collection and litigation recovery metrics, and a bankruptcy resolution, and
create one or more recommendations for debt collection optimization and a debt value sale based on the one or more patterns identified.

16. A non-transitory computer readable storage medium configured to store instructions that when executed cause a processor to perform:
identifying a new event associated with a consumer debtor account;
determining whether the new event comprises a status change or debt related change;
creating a file update comprising the status change or the debt related change and the new event; and
storing the file in a blockchain.

17. The non-transitory computer readable storage medium of claim 16, wherein the new event comprises one or more of a change in debt calculation, a status change of the consumer debtor, a new line of credit, a cancelled line of credit, a litigation record, a purchase, a sale, and wherein the status change or debt related change comprises one or more of an increase in debt, a decrease in debt and a change in credit status.

18. The non-transitory computer readable storage medium of claim 16, wherein the processor is further configured to perform:
identifying one or more parties requesting access to the file;
retrieving the file; and
accessing a plurality of transactions stored in the blockchain using metadata stored in the file.

19. The non-transitory computer readable storage medium of claim 18, wherein the processor is further configured to perform:
creating a notification comprising a plurality of consumer debtor account transactions; and
transmitting the notification to the plurality of parties.

20. The non-transitory computer readable storage medium of claim 16, wherein the processor is further configured to perform:
receiving an update to the file;
updating the file; and
storing the updated file in the blockchain;
retrieving a plurality of third parties registered to receive updated information;
creating a notification comprising the update to the file; and
transmitting the notification to the plurality of parties, wherein the plurality of third parties are stored in a separate file that is linked to the consumer debtor account.
